(19) United States
(12) Patent Application Publication
(10) Pub. No.: US 2017/0160987 A1
(43) Pub. Date: Jun. 8, 2017

(54) MULTILEVEL MAIN MEMORY INDIRECTION

(71) Applicant: Intel Corporation, Santa Clara, CA (US)

(72) Inventors: Robert J. Royer, JR., Portland, OR (US); Blaise Fanning, Folsom, CA (US)

(21) Appl. No.: 14/961,937

(22) Filed: Dec. 8, 2015

(51) Int. Cl. G06F 3/06

(52) U.S. Cl. CPC G06F 3/0659; G06F 3/0616; G06F 3/0625; G06F 3/0653; G06F 3/0683

(57) ABSTRACT

The present disclosure relates to a memory system with main memory. The main memory includes first level main memory and second level main memory. The first level main memory is configured to store indirection information providing reference to physical memory units of the second level main memory. Further, the memory system includes a memory controller configured to initiate an access of a physical memory unit of the second level main memory using the indirection information stored in the first level main memory.

### FIELD

The present disclosure generally relates to memory devices and, more particularly, to memory indirection concepts for multilevel main memory configurations.

### BACKGROUND

Computing systems and devices typically include main memory as primary storage to provide random memory access at a processor's data granularity. Conventionally, main memory uses volatile Dynamic Random Access Memory (DRAM). DRAM is faster than various nonvolatile memory technologies. DRAM also can be more resilient to usage, whereas some nonvolatile memory technologies may show degradation in stored data accuracy from usage. Therefore, nonvolatile memory technologies often use wear-leveling concepts to manage blocks in the non-volatile memory such that they all get used substantially evenly.

### BRIEF DESCRIPTION OF THE DRAWINGS

Some examples of apparatuses and/or methods will be described in the following by way of example only, and with reference to the accompanying drawings, in which

FIG. 1 schematically illustrates a computing system using two levels of main memory;

FIG. 2 shows a memory system according to an example;

FIG. 3 shows an example two-level memory architecture;

FIG. 4 illustrates a flowchart of an example method for indirection hinting in a multilevel main memory;

FIG. 5 shows an example of memory read/write flow;

FIG. 6 shows a flowchart of an example media management update flow; and

FIG. 7 shows a block diagram of an example device including multilevel main memory indirection.

### DESCRIPTION OF EMBODIMENTS

DRAM packages, such as Dual In-line Memory Modules (DIMMs), are limited in terms of their memory density, and are also typically expensive with respect to nonvolatile memory storage. Therefore, a two-level main memory architecture has been introduced recently. This two-level main memory architecture comprises a first level of lower latency main memory, also referred to as near memory, and a second level of higher latency main memory, also referred to as far memory. In one implementation, the near memory may be used as a low latency cache of the far memory. Further, the near memory may use volatile memory, such as DRAM, while the far memory may use wear-leveled memory, such as phase-change RAM, resistive RAM, magneto-resistive RAM, or Flash memory, for example.

Various examples will now be described more fully with reference to the accompanying drawings in which some examples are illustrated. In the figures, the thicknesses of lines, layers and/or regions may be exaggerated for clarity.

Accordingly, while further examples are capable of various modifications and alternative forms, some examples thereof are shown by way of example in the figures and will herein be described in detail. It should be understood, however, that there is no intent to limit examples to the particular forms disclosed, but on the contrary, examples are to cover all modifications, equivalents, and alternatives falling within the scope of the disclosure. Like numbers refer to like or similar elements throughout the description of the figures.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular examples only and is not intended to be limiting of further examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which examples belong. It will be further understood that terms, e.g., those defined in commonly used dictionaries, should be interpreted as having a meaning that is consistent with their meaning in the context of the relevant art, unless expressly defined otherwise herein.

Portions of examples and corresponding detailed description are presented in terms of software, or algorithms and symbolic representations of operation of data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative examples will be described with reference to acts and symbolic representations of operations (e.g., in the form of flowcharts) that may be implemented as program modules or functional processes including routines, programs, objects, components, data structures, etc., that perform particular tasks or implement particular abstract data types and may be implemented using existing hardware at existing network elements or control nodes. Such existing hardware may include one or more Central Processing Units (CPUs), Digital Signal Processors (DSPs), Application-Specific Integrated Circuits, Field Programmable Gate Arrays (FPGAs), computers, or the like.

Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Furthermore, examples may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a computer readable storage medium. When implemented in software, a processor or processors will perform the necessary tasks.

A code segment may represent a procedure, function, subprogram, program, routine, subroutine, module, software package, class, or any combination of instructions, data structures or program statements. A code segment may be coupled to another code segment or a hardware circuit by passing and/or receiving information, data, arguments, parameters or memory contents. Information, arguments, parameters, data, etc. may be passed, forwarded, or transmitted via any suitable means including memory sharing, message passing, token passing, network transmission, etc.

Examples described in the present disclosure are directed to system main memory comprising multiple levels of main memory. Different examples described in the present disclosure relate to memory controllers for main memory comprising first level main memory of volatile memory and second level main memory of wear-leveled memory, to memory controllers for wear-leveled memory, to memory systems, to apparatuses for memory systems using a first level of volatile memory and a second level of wear-leveled main memory, and to methods for indirection hinting in a multi-level main memory.

Multiple levels of main memory include at least two levels of main memory. Main memory refers to physical memory that is internal to a computer device and accessible from a Central Processing Unit (CPU) via a memory bus. The expression “main” is used to distinguish the memory from external mass storage devices such as disk drives, for example. Main memory may include cached subsets of system disk level storage in addition to, for example, run-time data. Main memory also differs from CPU internal memory, such as processor registers or processor cache. Most actively used information in the main memory may be duplicated in the processor cache, which is faster, but of much lesser capacity than main memory. On the other hand, main memory is slower, but has a much greater storage capacity than processor registers or processor cache. Another conventional term for main memory is Random Access Memory (RAM). RAM is a type of computer memory that can be accessed randomly, which means that any byte of memory can be accessed without touching preceding bytes.

In examples described herein, different levels of main memory may have different memory access latencies. For example, a first level of main memory may be faster than a second level of main memory. Examples using two levels of main memory will alternatively be referred to herein as ‘2LM’.

A multiple level main memory according to examples includes a first level main memory portion, alternatively referred to herein as “near memory”, comprising volatile memory, for example, DRAM. Note that in principle also faster Static Random Access Memory (SRAM) would be possible as first level main memory. However, SRAM can be considerably more expensive than DRAM. Examples of near memory are not limited in this manner. The multiple level main memory also includes a second level main memory portion, alternatively referred to herein as “far memory”, which may comprise wear-leveled or wear-managed memory. Wear leveling refers to techniques used for prolonging the service life of some kinds of nonvolatile memories. Wear leveling attempts to work around read/write limitations by arranging data so that erasures and re-writes are distributed possibly evenly across a storage medium. For example, a memory controller may provide for interchanging memory portions over the lifetime of the memory at times when it is detected that they are receiving significantly uneven use.

Near memory may comprise smaller and slower (with respect to far memory) volatile memory, while the far memory may comprise larger and slower (with respect to the near memory) nonvolatile memory storage in some examples. Volatile memory can be memory whose state (and therefore the data stored on it) is indeterminate if power is interrupted to the device. Dynamic volatile memory requires refreshing the data stored in the device to maintain state. One example of dynamic volatile memory includes DRAM (dynamic random access memory), or some variant such as synchronous DRAM (SDRAM). A memory subsystem as described herein may be compatible with a number of memory technologies, such as DDR3 (dual data rate version 3, original release by JEDEC (Joint Electronic Device Engineering Council) on Jun. 27, 2007, currently on release 21), DDR4 (DDR version 4, initial specification published in September 2012 by JEDEC), LPDDR3 (low power DDR version 3, JESD209-3B, August 2013 by JEDEC), LPDDR4 (LOW POWER DOUBLE DATA RATE (LPDDR) version 4, JESD209-4, originally published by JEDEC in August 2014), WIO2 (Wide I/O 2 (WideIO2), JESD229-2, originally published by JEDEC in August 2014), HBM (HIGH BANDWIDTH MEMORY DRAM, JESD235, originally published by JEDEC in October 2013), DDR5 (DDR version 5, currently in discussion by JEDEC), LPDDR5 (currently in discussion by JEDEC), HBM2 (HBM version 2), currently in discussion by JEDEC), and/or others, and technologies based on derivatives or extensions of such specifications.

Examples of nonvolatile memory include three dimensional crosspoint memory device, or other byte addressable nonvolatile memory devices, multi-threshold level NAND flash memory, NOR flash memory, single or multi-level Phase Change Memory (PCM), Resistive RAM (ReRAM/RRAM), phase-change RAM exploiting certain unique behaviors of chalcogenide glass, nanowire memory, ferroelectric transistor random access memory (FeTRAM), Ferroelectric RAM (FeRAM/FRAM), Magnetoresistive Random-Access Memory (MRAM), Phase-change memory (PCM/PCMe/PRAM/PCRAM, aka Chalcogenide RAM/CRAM) conductive-bridging RAM (cbRAM, aka programmable metallization cell (PMC) memory), SONOS (“Silicon-Oxide-Nitride-Oxide-Silicon”) memory, FJRAM (Floating Junction Gate Random Access Memory), Conductive metal-oxide (CMOx) memory, battery backed-up DRAM spin transfer torque (STT)-MRAM, magnetic computer storage devices (e.g. hard disk drives, floppy disks, and magnetic tape), or a combination of any of the above, or other memory, and so forth. In one embodiment, the nonvolatile memory can be a block addressable memory device, such as NAND or NOR technologies. Embodiments are not limited to these examples.

In some examples, the far memory may be presented as “main memory” to a host Operating System (OS), while the near memory may be used as a cache for the far memory that is transparent to the OS. This concept allows for reducing the average time to access data from the far memory presented as main memory to the OS. The near memory cache may be a smaller, faster memory which stores copies of the data from frequently used far memory locations. Yet, the near memory may differ from conventional CPU internal processor cache, for example, in that it is larger and slower than CPU internal cache (e.g., SRAM cache).

Management of two-level main memory may be done by a combination of logic and modules executed via a host CPU. Near memory may be coupled to the host system CPU via a relatively high bandwidth, low latency connection for efficient processing. Far memory may be coupled to the CPU via a relatively lower bandwidth, high latency connection as compared to that of the near memory.

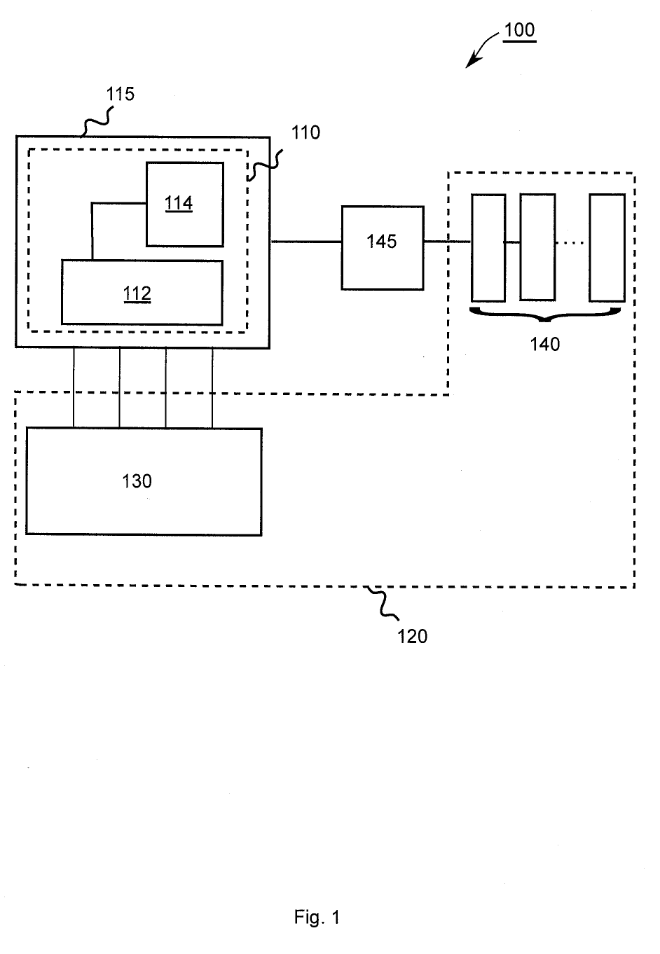

FIG. 1 schematically illustrates an example computing system 100 using a 2LM architecture.

In the illustrated example, the computing system 100 comprises a CPU package 115 and main memory 120, which includes a level of volatile memory shown as near memory 130, and a level of wear-leveled memory, shown as far memory 140. Main memory 120 may provide run-time data storage and access to the contents of optional system disk storage memory (not shown) to a CPU. Disk storage memory may also be referred to as secondary memory, while main memory 120 may also be referred to as primary memory. CPU may optionally include CPU internal processor cache, e.g., using Static Random Access Memory (SRAM), which would store a subset of the contents of main memory 120.

Near memory 130 may comprise volatile memory, for example, in form of DRAM packages arranged on one or more DIMMs. In some examples, near memory 130 could even use SRAM. Far memory 140 may comprise either wear-leveled volatile or wear-leveled nonvolatile memory. In particular, nonvolatile far memory may experience slower access times compared to near memory 130. An example of wear-leveled nonvolatile memory is phase-change RAM.

In the example of FIG. 1, near memory 130 may serve a low-latency and high-bandwidth cache of far memory 140, which may have considerably lower bandwidth and higher latency for CPU access.

In the illustrated example, near memory 130 is managed by Near Memory Controller (NMC) 112. NMC 112 may be part of a memory subsystem 110 in CPU package 115.

Memory subsystem 110 will also be referred to memory controller in the sequel. However, the skilled person having benefit from the present disclosure will appreciate that also other implementations are possible. For example, NMC 112 could also be located on-chip with the CPU or could be located off-chip separately between CPU package 115 and near memory 130.

Far memory 140 may be managed by a separate Far Memory Controller (FMC) 145. In the example of FIG. 1, FMC 145 is not part of the CPU package 115 but located outside thereof. For example, FMC 145 may be located close to far memory 140. FMC 145 may report far memory 140 to the system OS as main memory—i.e., the system OS may recognize the size of far memory 140 as the size of system main memory 120. The system OS and system applications may be “unaware” of the existence of near memory 130 as it may act as a “transparent” cache of far memory 140.

FMC 145 may also manage other aspects of far memory 140. In examples where far memory 140 comprises nonvolatile memory, it is understood that nonvolatile memory is subject to degradation of memory segments due to significant reads/writes. Thus, far memory 140 may have limited endurance and as a result may be wear managed. FMC 145 may therefore execute functions including wear-leveling, bad-block avoidance, and the like in a manner transparent to system software. For example, executing wear-leveling logic may include selecting segments from a free pool of clean unmapped segments in far memory 140 that have a relatively low erase cycle count. Additionally, wear management can add swapping user data from a physical location with high cycle count with user data from a physical location with low cycle count. In order to successfully wear manage far memory 140, an indirection system may be leveraged allowing the computing system 100 to retrieve user data regardless of its physical location. To save cost this indirection system may be stored in a memory in or accessible to FMC 145 and/or far memory 140, for example.

The concept of indirection allows a conversion of logical memory addresses received from a host to physical memory addresses which can be used to address particular memory portions which are used as main memory. A logical address is the address at which an item (e.g., memory cell, storage element, network host, etc.) appears to reside from the perspective of an executing application program. A logical address may be different from the physical address due to the operation of an address translator or mapping function. Instead, a physical address is a memory address that is represented in the form of a binary number on an address bus circuitry in order to enable a data bus to access a particular storage cell of main memory. For example, a file/program appears as a contiguous region of (logical) memory space addressed as bytes 0 through the size of the file/program minus one to a user or an application program. In reality, such a file/program is stored as various physical blocks of data scattered throughout the physical memory. Accordingly, some address translation method is needed to convert, or translate, the file/program offsets provided by the application (logical addresses) to physical addresses in the memory device. This may be done using so-called indirection tables providing a mapping between logical and corresponding physical memory addresses.

In the illustrated example system of FIG. 1, memory controller 110 further comprises a 2LM engine module/logic 114. The ‘2LM engine’ may be regarded as a logical construct that may comprise hardware and/or micro-code extensions to support two-level main memory 120. For example, 2LM engine 114 may maintain a full tag table that tracks the status of all architecturally visible elements of far memory 140. For example, when a CPU, core, or processor attempts to access a specific data segment in main memory 120, 2LM engine 114 may determine whether said data segment is included in near memory 130. If it is not, 2LM engine 114 may fetch the data segment from far memory 140 and subsequently write the data segment to near memory 130—similar to a conventional cache miss. It is to be understood that, because near memory 130 acts as a ‘cache’ of far memory 140, 2LM engine 114 may further execute data prefetching or similar cache efficiency processes.

Near memory 130 may be smaller in size than far memory 140, although an exact ratio may vary based on, for example, intended system use. In this example, it is to be understood that because far memory 140 may comprise denser, cheaper nonvolatile memory, main memory 120 may be increased cheaply and efficiently and independent of the amount of DRAM, for example, in near memory 130 in the system.

By storing a far memory indirection system on FMC 145 and/or far memory 140, a memory request from the CPU may involve one or even more indirection lookups at the FMC 145 and/or far memory 140, thereby increasing latency for each memory request. This latency is not insignificant and can account for, e.g., 20-40% of the total latency for a memory request. For example, if FMC 145 is required to perform an indirection lookup for every request, this may cause on average an additional 100 ns of latency or 20% for every read request.

Examples described in the present disclosure seek to provide an improved concept for handling indirection information for multi-level main memory concepts such as the 2LM example of FIG. 1.

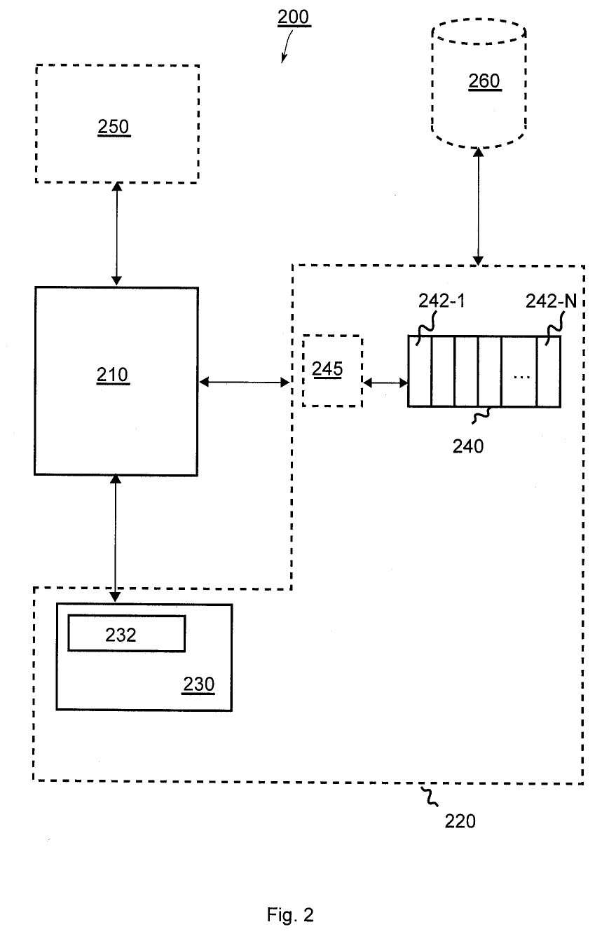

FIG. 2 shows a block diagram of a memory system 200 according to an example.

Memory system 200 comprises a memory controller 210 and main memory 220. Similar to the example of FIG. 1, main memory 220 includes first level main memory of volatile memory referred to as near memory 230 and second level main memory of wear-leveled memory referred to as far memory 240. Further levels of main memory are conceivable. Near memory 230 is configured to store indirection information 232 providing reference to physical memory units 242 of far memory 240. Memory controller 210 is configured to initiate storage of and access to the indirection information 232 in near memory 230 and to initiate access of one or more physical memory units 242 of far memory 240 using the indirection information 232 stored in near memory 230.

The memory system 200 may be used in computer systems, such as general purpose or embedded computer systems, for example. Memory controller 210 may be directly or indirectly coupled to an optional CPU 250 of a computer system to allow memory requests of the CPU 250 to main memory 220 via memory controller 210. Memory controller 210 may comprise analog and digital hardware components and software configured to at least partially implement functionalities similar to NMC 112, 2LM engine 114 and/or FMC 145. That is to say, in some examples, memory controller 210 may regarded as a logical entity comprising functionalities for controlling both near memory 230 and far memory 240. Thereby the physical implementation of memory controller may be spread over multiple physical hardware entities, similar to NMC 112 and FMC 114 of FIG. 1. At least some portions of memory controller 210 and CPU 250 may be integrated into a common semiconductor package. To further improve latency, near memory 230 may also be integrated into the same semiconductor package housing CPU 250 and at least a portion of memory controller 210.

As has been explained above, an access latency of near memory 230 may be shorter than an access latency of far memory 240. While near memory 230 may include DRAM, far memory 240 may include nonvolatile memory.

While main memory 220 including both near memory 230 and far memory 240 may be considered as primary memory that can be accessed by CPU 250 in a random fashion, memory system 200 may further comprise an optional secondary memory 260 of nonvolatile memory. In contrast to main memory 220, secondary memory 260 cannot be directly accessed by CPU 250. Therefore, far memory 240 may comprise a cached subset of the secondary memory 260. In some examples, an access latency of far 240 may be (substantially) shorter than an access latency of the secondary memory 260, which may comprise disk storage, in particular Hard Disk Drive (HDD) storage or Solid State Disk (SSD) storage. An example SSD uses 2D or 3D NAND-based flash memory.

Memory controller 210 may provide indirection ‘hints’ to far memory 240 on a potential current physical location for a requested piece of data. For example, a hint can comprise a far memory physical address currently or previously corresponding to a logical address. The far memory hints are stored in near memory 230 and can be retrieved by CPU 250 with little to no latency depending on the memory controller design, since an access latency of near memory 230 may be substantially shorter than an access latency of far memory 240. Based on an indirection hint, far memory 240 or an optional associated Far Memory Controller (FMC) 245 may then try to retrieve the user data at the specified physical location in far memory 240. In other words, far memory 240 and/or FMC 245 may be configured to attempt an access of the requested user data at a physical address of far memory 240 identifeed by the indirection hint 232 stored in near memory 230. For example, FMC 245 may resolve a hint in form of a far memory physical address into actual commands to far memory 240 using a set of fixed function translations. During this process, far memory 240 may check its associated own indirection system to see if the indirection hint is accurate. If it is, far memory 240 and/or FMC 245 may return the requested user data. Otherwise, far memory 240 and/or FMC 245 may perform its normal indirection lookup and resolve an actual physical location of the requested user data.

The indirection information 232 (indirection hints) stored in near memory 230 may comprise a mapping between at least one logical address and at least one physical address of or in far memory 240. The indirection “hints” 232 denote indirection information, e.g., logical-to-physical address mapping that was valid previously and may still be valid currently, i.e., at the moment of a current user data request (memory request). That is to say, the indirection hints 232 in the first level main memory 230 may be based on previously valid mappings between logical addresses and corresponding physical addresses of far memory 240. However, due to wear leveling schemes applied to far memory 240 an actual or current mapping between the logical address and a physical address of far memory 240 may be different from the previously valid mapping. In other words, due to wear leveling the indirection table of far memory 240 may have changed in the meantime. Therefore the indirection information 232 stored in near memory 230 is referred to herein as indirection ‘hints’.

Examples of the indirection hinting embodiments proposed herein versus providing the actual physical address may be help improve multilevel main memory embodiments, such as 2LM. While it might seem easier to the CPU to manage indirection completely, there are multiple potential complications that render examples of the proposed solution a more attractive system.

For example, it is likely that far memory 240 and/or FMC 245 will always need to move user data to different physical address as part of its media management policies (wear leveling). If the CPU was directly managing the indirection system, one would be required to design a notification method for indirection update that is 100% reliable, otherwise data corruption would occur. Getting an indirection hint wrong may result in increased latency but may still always return the correct user data as will be described in more detail. As long as the indirection hinting method is accurate most of the time, one may see a latency benefit for this approach. One could argue that media management policies, like wear leveling of far memory, be done by the CPU, but this approach may involve the 2LM subsystem in the CPU being designed for future generations of non-volatile and/or wear-leveled far memory which attributes are not known at the time of CPU design lockdown. Furthermore, the expansion or the exchange of far memory might not be possible.

For another example, power cycles, especially unexpected power losses, can create a fair amount of complexity around rebuilding the correct state of an indirection table. Much of the validation time in SSD is spent validating indirection table consistency. In example implementations, the indirection hints 232 of near memory 230 do not need to be correct or even provided. The CPU 250 can also request user data without an indirection hint causing far memory 240 to perform its own indirection lookup and return the correct user data, along with its current location for future access. In this way, new indirection hints may be built up in near memory 230 after unexpected power loss.

By making an indirection hint 232 in near memory 230 a hint (based on previous experience) and not an absolute reference one does not need for it to be 100% correct. This may simplify implementation at the cost of increased latency if the CPU hints wrong. But even if the CPU is wrong 1% of the time, it is still a net win on latency versus no hinting. It may be expected that the hints are correct in >99% of the time.

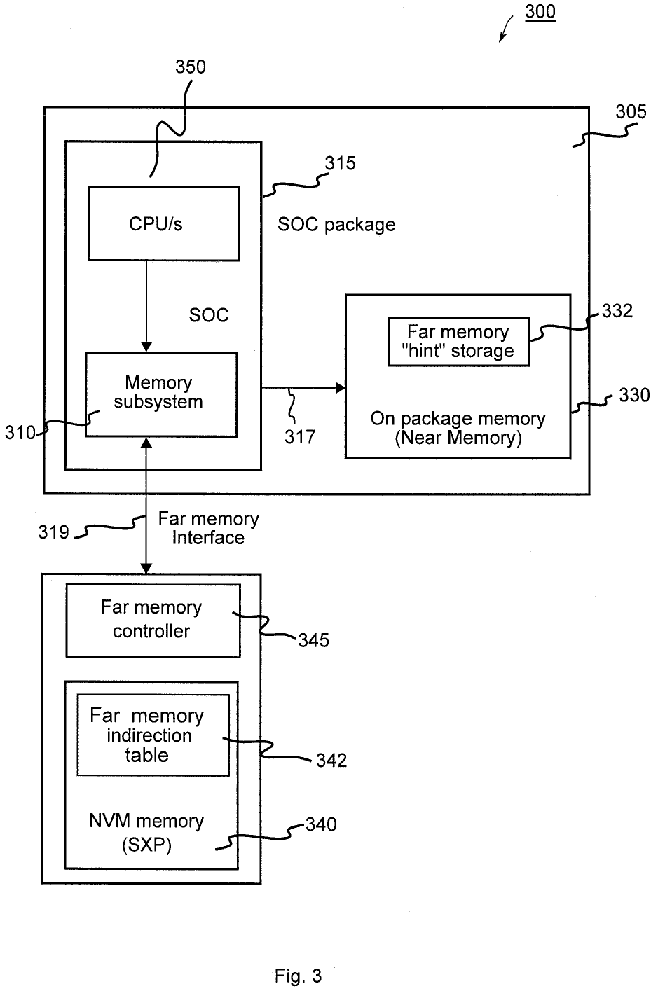

Turning now to FIG. 3, it is shown another example of a multilevel memory system 300.

The memory system 300 comprises one or more CPUs 350 (each CPU can include one or more processor cores), a multi-level main memory controller 310, which will also be referred to as memory subsystem, and multi-level main memory. Memory subsystem/controller 310 may comprise analog and digital circuit components and software implementing memory controller functionalities similar to NMC 112 and 2LM engine 114 of FIG. 1. In the illustrated example, the one or more CPUs 350 and the memory controller 310 are integrated on a common chip forming a System-On-Chip (SoC) 315. A SoC may be understood as an Integrated Circuit (IC) that integrates several components of an electronic system into a single chip/die. It may contain digital, analog, mixed-signal, and even radio-frequency functions—all on a single chip substrate. The skilled person having benefit from the present disclosure will appreciate that the CPU(s) 350 and the memory subsystem 310 could also be integrated on separate chips in other implementations.

The multiple-level main memory of computing system 300 comprises a first level main memory of volatile memory referred to as near memory 330, e.g., DRAM, and a second level main memory of Non-Volatile Memory (NVM) referred to as far memory 340.

In the illustrated example, SoC 315 and near memory 330 together form a System in Package (SiP) 305 comprising a number of chips in a single package. The skilled person having benefit from the present disclosure will appreciate that SoC 315 and near memory 330 could also be implemented in separate packages in other example implementations. SoC 315 is coupled to near memory 330 via a high bandwidth, low latency connection or interface 317. Far memory 340 and an associated Far Memory Controller (FMC) 345 are located outside SiP 305 and are coupled to SoC 305 via a lower bandwidth, higher latency connection or interface 319 (with respect to connection 317). Far memory 340 and FMC 345 may form a far memory module.

FIG. 3 illustrates an example 2LM architecture where near memory (e.g., DRAM) 330 is physically located on SoC and far memory 340 is a discrete module with an FMC Application-Specific Integrated Circuit (ASIC) 345 and 1-n Non-Volatile Memory (NVM) die. This example architecture and associated 2LM algorithms may be assumed for this disclosure. However, the skilled person will appreciate that the present disclosure can have the similar benefits in different 2LM architectures, for example, where the near memory 330 is not in the SoC package and/or the far memory controller 345 is integrated into the SoC. In some embodiments, some portion or all of FMC 345 can be incorporated into SoC 315.

Near memory 330 comprises a far memory ‘hint’ storage for storing indirection information (indirection hints) 332 providing reference to physical addresses of far memory 340. Additionally, far memory 340 or its associated FMC 345 maintains an own far memory indirection table 342. As mentioned before, the ‘hint’ storage may comprise far memory physical addresses which are currently corresponding or have previously corresponded to logical addresses.

In the example of FIG. 3, memory controller 310 is configured, upon a memory request of CPU 350, to access the indirection information 332 stored in near memory 330 and to initiate an access of a physical memory address of far memory 340 using the indirection information 332 stored in near memory 330. Hence, memory controller 310 may be configured to receive, from CPU 350, a memory request for accessing a memory portion of far memory 340. Based on that memory request, memory controller 310 may generate a logical address for the requested memory portion and look up indirection information 332 for the memory portion in the near memory 330 using the generated logical address. Memory controller 310 may then generate a memory request for far memory 340 or FMC 345 using the looked-up indirection information 332 of near memory 330. The generated memory request may then include information on a (potential) physical address of far memory 340 corresponding to the logical address. The memory request may then be transmitted from memory controller 310 to far memory 340 or FMC 345 via interface 319.

FMC 345, on the other end of interface 319, may be configured to receive, from memory controller 310, the memory request for far memory 340. The received memory request may include information on a (potential) physical address of far memory 340. Optionally, also information on the logical address corresponding to the (potential) physical address derived from the indirection information 332 of near memory 330 may be present. In response to the received memory request, FMC 345 may be configured to access far memory 340 at the (potential) physical address of the received memory request.

As has been described before, the indirection hint storage 332 of near memory 330 may comprise indirection information derived from one or more previously valid far memory indirection tables 342. That is to say, the indirection information 332 stored in near memory 330 may be a compressed or uncompressed image of the indirection information 342 in far memory 340. FMC 345 may be configured to modify, according to a wear leveling scheme, the indirection information 342 of far memory 340 providing a mapping between at least one logical address and at least one corresponding physical address of far memory 340. Therefore, one or more once valid individual hints comprised by the indirection information 332 stored in near memory 330 may have become invalid or outdated. As such, the (potential) physical address of the received memory request may in rare cases not match a current logical-to-physical address mapping of far memory 340. In this event, FMC 354 may then access far memory 340 at a different physical address matching the current logical-to-physical address mapping of far memory 340 and return the current logical-to-physical address mapping of far memory 340 to memory controller 310 and near memory 330.

In the example architecture of FIG. 3, SiP 305 contains both near memory 330 and SoC 315. Memory subsystem/controller 310 in the SoC 315 encapsulates the 2LM algorithms which will also implement methods and processes described below. In addition, a section 332 of near memory 330 is allocated for far memory “hints”. The allocated memory section 332 does not need to be large. For example, 1 MB of far memory hints may be enough for every reported 1 GB of far memory 340. In some examples, the memory portion 332 may have a size of about 8-16 MB for typically configured systems out of 1-4 GB of near memory 330.

The far memory module of FIG. 3 may be a discrete module that contains both the FMC 345, e.g. in form of an ASIC, and the NVM media 340. This media 340 may be wear managed and the necessary indirection table 342 may be stored on NVM to save cost and power. Roughly speaking, near memory 330 may be >10× faster than far memory 340.

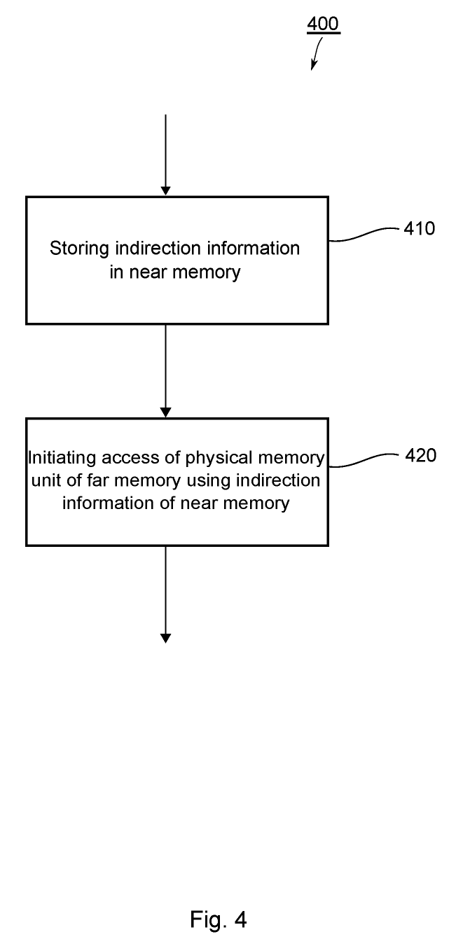

Turning now to FIG. 4, it is illustrated a high-level flowchart of a method 400 for indirection hinting in a multi-level main memory.

Method 400 comprises storing 410, in near memory 230, 330, indirection information (indirection hints) 232, 332 providing reference from one or more logical addresses to one or more physical addresses of far memory 240, 340. Method 400 further includes initiating 420 access of a physical memory unit of far memory 240, 340 using the indirection information 232, 332 stored in near memory 230, 330.

The skilled person having benefit from the present disclose will appreciate that some basic examples of method 400 can be implemented using memory controller 210, 310 together with near memory 230, 330 and far memory 240, 340. Therefore, memory controller 210, 310 may also be regarded as an apparatus for a memory system using a first level of volatile memory (near memory) and a second level of wear-leveled main memory (far memory). The apparatus provides devices for storing, in near memory, indirection information providing reference to physical memory addresses of far memory, and devices for accessing a physical memory address of far memory using the indirection information stored in near memory. For more advanced examples of method 400 FMC 245, 345 may additionally be required as part of the apparatus.

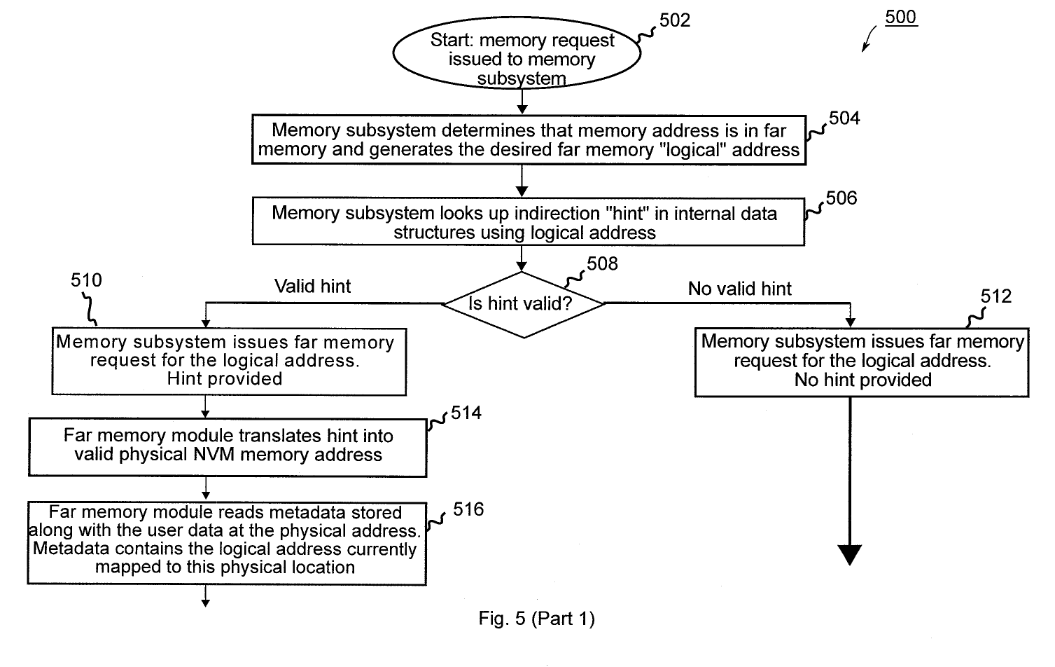

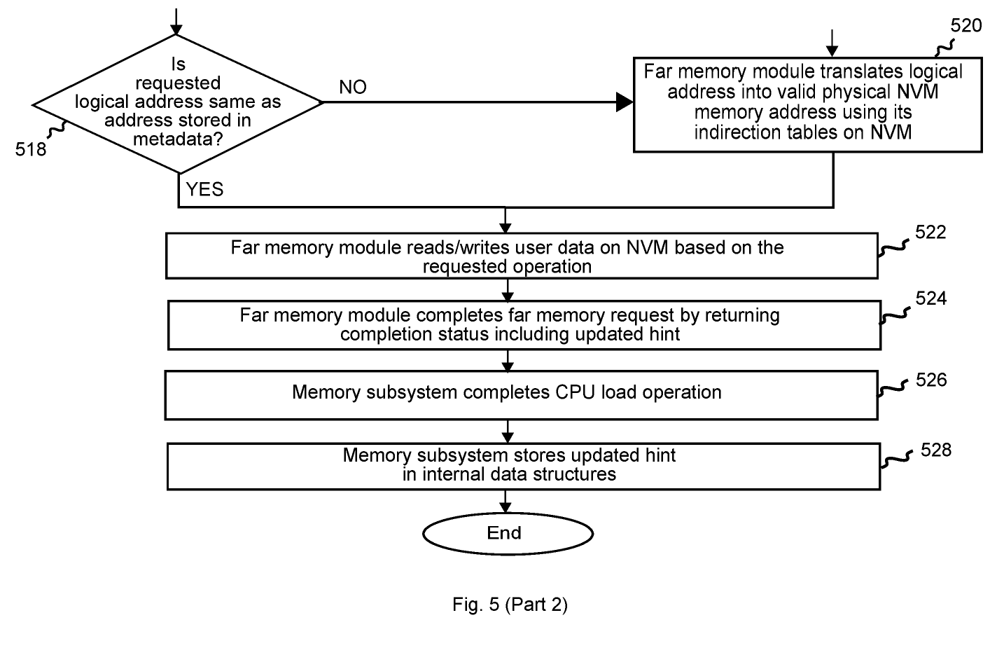

A more detailed example of a process 500 for indirection hinting in a multi-level main memory will now be described with reference to FIG. 5.

Process 500 starts with issuing 502 a memory request from CPU 350 to memory controller 310, i.e., the CPU 350 requests a transfer operation with the multi-level main memory. The memory request includes a requested memory address. Next, memory controller 310 may determine 504 that the requested memory address is in far memory 340 and therefore generate a far memory logical address for the requested memory address. Memory controller 310 may then use indirection information 332 stored in near memory 330 to look up 506 an indirection ‘hint’ for the far memory logical address.

Hence, process 500 may include requesting, from CPU 310, access to a memory portion of the multi-level main memory (see 502). Memory controller 310 may determine whether the memory portion is associated with far memory 340. If so, a requested logical address may be generated for the memory portion and indirection information 332 for the memory portion may be looked up in near memory 330 using the requested logical address.

Process 500 may include two branches depending on whether an indirection ‘hint’ is provided for the requested logical address (valid hint′) or not (no valid hint′).

For example, no indirection hint may be available in near memory 330, if the far memory logical address has never been requested before or has only been requested a long time ago. In this case there might not be any indirection information 332 stored in near memory 330 corresponding to the far memory logical address. In such a case, where no indirection hint is available, memory controller 310 may issue 512 a far memory request for the far memory logical address. Here, the far memory request does not include an indirection hint from near memory 330. For example, memory subsystem 310 may send a logical address (pre indirection lookup) instead of a physical addresses (post indirection lookup). Far memory controller 345 may then receive the far memory request and translate 520 the far memory logical address of the far memory request from memory subsystem 310 into a valid physical NVM address using own indirection tables stored in the far memory 340 and/or FMC 345.

If, on the other hand, an indirection hint can be provided for the far memory logical address, memory controller 310 may issue 510 a far memory request for the far memory logical address. Here, the far memory request may include the indirection hint from near memory 330. For example, a hint may be provided by memory subsystem 310 including CPU as part of a request packet (command) which may be set for every read or write operation. For example, memory subsystem 310 may send a physical addresses (post indirection lookup) instead of or in addition to a logical address (pre indirection lookup). In the latter example, a request packet may include both the logical address and the hint in form of a physical address. FMC 345 may identify valid hints in various ways. For example, the CPU may turn on the ‘hinting’ capability by setting one or more control bits in a register of FMC 345. In such case FMC 345 may look at or consider the hint only if the register value is a non-null value. FMC 345 may then translate 514 the indirection hint included in the far memory request into a physical NVM address. In some examples, metadata (i.e., data about data) along with user data may be accessed 516 at the physical NVM address of far memory. Thereby the metadata may comprise a logical address which is currently mapped to the physical NVM address. If the requested far memory logical address corresponds to the current logical address provided by the metadata, 518, the far memory module may read/write 522 user data based on the requested operation using the physical NVM address. If, on the other hand, the requested far memory logical address does not correspond to the current logical address provided by the metadata, FMC 345 may then translate 520 the far memory logical address of the far memory request from memory controller 310 into another valid physical NVM address using one or more own indirection tables 342 stored in far memory 340 and/or FMC 345.

Process 500 may hence further include sending and receiving a memory request for far memory 340 using the indirection information looked up in near memory 330. Prior to issuing the memory request by memory controller 310, the indirection information of near memory 330 may be used to obtain a physical address of far memory 340 so that information on the requested logical address and the physical address may be included in the memory request. At far memory 340 and/or FMC 345, metadata may then be accessed at the obtained physical address of far memory 340. The metadata may comprise a logical address currently mapped to the obtained physical address according to current indirection tables 342 of far memory 340. At far memory 340 and/or FMC 345, it may then be determined whether the requested logical address of the memory request corresponds to the logical address of the metadata. If so, user data may be read/written from/to the physical address of far memory 340. Otherwise the requested logical address may be translated into a valid physical address of far memory 340 using current indirection information 342 stored in far memory 340 and user data may be read/written from/to the valid physical address.

In act 524, the far memory module or its associated FMC 345 may complete the far memory request by returning a completion status including an updated indirection hint for the physical NVM address. The updated hint for the requested logical address may comprise the updated physical NVM address. In other words, updated indirection information may be returned from far memory 340 to near memory 330 via FMC 345 and memory controller 310. In an alternative example, an updated indirection hint could be provided from FMC 345 to memory controller 310 only in case a current logical-to-physical address mapping differs from a provided indirection hint or no indirection hint was provided at all.

In acts 526 and 528, memory controller 310 may complete a CPU load operation and store the updated hint in internal data structures of near memory 330.

FIG. 5 describes an example flow of a memory request once it is determined by memory controller 310 that the requested location is only in far memory 340 (near memory miss). While read and write behavior are somewhat different, examples of process 500 may be applied uniformly to both reads and writes. In this flow, regardless if memory controller 310 has the right hint or not, the correct user data may always be returned/modified. In addition, the far memory module may return the correct hint as part of the completion flow for each access, allowing the host to update its hint storage with the current correct hint (logical-to-physical mapping). This also lets memory controller 310 “page fault” the hint storage 332 in near memory 330 allowing for it to be constructed during normal operation. In addition to the read/write flow, the far memory module, e.g. FMC 345, may be performing media management operations such as wear leveling that will result in the update of its indirection table.

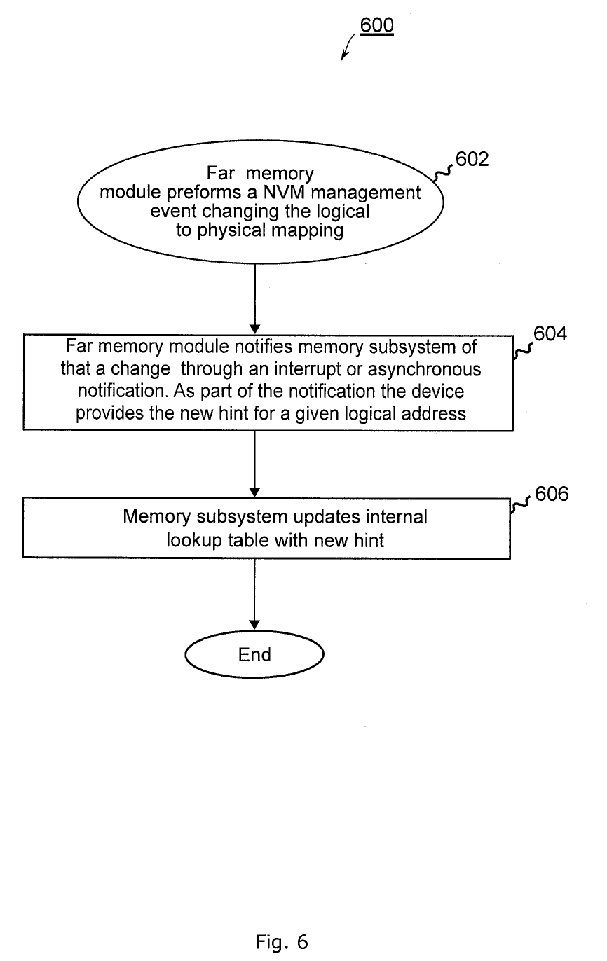

Turning now to FIG. 6, it is described an example process 600 that can be used to update indirection hints in near memory 330.

In case that far memory 340 and/or far memory controller 345 performs a NVM management event changing the current logical address to physical address mapping of far memory (see act 602), far memory 340 and/or FMC 345 may notify memory controller 310 of that change. This notification may be through an interrupt or an asynchronous notification, for example (see 604). That is to say, FMC 345 may be configured to modify, according to a wear leveling scheme, a mapping between at least one logical address and at least one corresponding physical address of far memory 340. FMC 345 of far memory 340 may be configured to issue the notification message using an interrupt or an asynchronous notification. Thereby an interrupt may be understood as a signal to the CPU emitted by hardware or software indicating an event that needs immediate attention. Similarly, when using asynchronous notifications an application can receive a signal whenever an event becomes available and need not concern itself with polling. As part of the notification, far memory 340 and/or FMC 345 may provide a new indirection hint for a given logical address. Memory controller 310 may then update the internal lookup-table 332 with the new indirection hint, see 606.

While memory controller 310 can build up hints as part of normal operation after near memory loses its state due to a power cycle, S3 transition, etc., a faster memory is desired. Before transiting to a power state where the contents of near memory 330 will be lost, the hint storage 332 may be saved to far memory 340 along with any user data not current stored in far memory 340 (i.e. dirty data). That is, in some examples memory controller 310 may be configured to initiate a transfer of the stored indirection information from near memory 330 to far memory before transiting to a low power state of the system where content of near memory 330 is lost. The memory controller 310 may further be configured to initiate an optional additional transfer of user data currently not stored in far memory 340 from the CPU 350 or near memory 330 to far memory 340. Upon resume from the low power state the hint storage 332 can be copied back in either all at once before user requests are allowed or in parallel with user requests. Memory controller 310 may be configured to initiate a transfer of the indirection information 332 back from far memory 340 to near memory 330 upon resume from the low power state. The hint storage 332 may be small, for example, in the order of 1 MB of near memory for every 1 GB of far memory 340 or roughly 16 MB for a system that reports 16 GB of main memory.

To summarize, several processes have been described in this disclosure, including the hinting process applied to far memory requests. Further is the process to update the hints stored by memory controller when the far memory module completes a wear leveling operation. Yet further is a method that can be employed during system power on to quickly rebuild the hint storage in the memory controller. The described examples of indirection hinting may provide improved latency in multi-level main memory, in particular 2LM. Examples of the present disclosure may be particularly useful for wear-leveled far memory.

The skilled person having benefit from the present disclosure will appreciate that several aspects of the described multilevel memory systems can be implemented by separate components thereof, such as memory controller 210, 310 on the one hand and far memory controller 245, 245 on the other hand. Together with near and far memory they form a multilevel memory system.

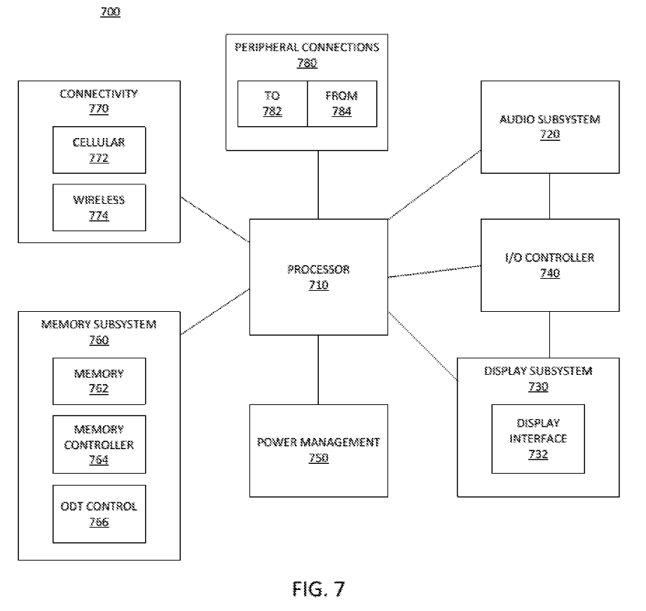

FIG. 7 is a block diagram of an example of a device, for example a mobile device, in which multilevel main memory indirection can be implemented. Device 700 may represent a mobile computing device, such as a computing tablet, a mobile phone or smartphone, a wireless-enabled e-reader, wearable computing device, or other mobile device. It will be understood that certain of the components are shown generally, and not all components of such a device are shown in device 700.

Device 700 includes a processor 710, which performs the primary processing operations of device 700. Processor 710 can include one or more physical devices, such as microprocessors, application processors, microcontrollers, programmable logic devices, or other processing means. The processing operations performed by processor 710 include the execution of an operating platform or operating system on which applications and/or device functions are executed. The processing operations include operations related to I/O (input/output) with a human user or with other devices, operations related to power management, and/or operations related to connecting device 700 to another device. The processing operations can also include operations related to audio I/O and/or display I/O.

In one embodiment, device 700 includes an audio subsystem 720, which represents hardware (e.g., audio hardware and audio circuits) and software (e.g., drivers, codecs) components associated with providing audio functions to the computing device. Audio functions can include speaker and/or headphone output, as well as microphone input. Devices for such functions can be integrated into device 700, or connected to device 700. In one embodiment, a user interacts with device 700 by providing audio commands that are received and processed by processor 710.

A display subsystem 730 represents hardware (e.g., display devices) and software (e.g., drivers) components that provide a visual and/or tactile display for a user to interact with the computing device. Display subsystem 730 includes display interface 732, which includes the particular screen or hardware device used to provide a display to a user. In one embodiment, display interface 732 includes logic separate from processor 710 to perform at least some processing related to the display. In one embodiment, display subsystem 730 includes a touchscreen device that provides both output and input to a user. In one embodiment, display subsystem 730 includes a high definition (HD) display that provides an output to a user. High definition can refer to a display having a pixel density of approximately 100 PPI (pixels per inch) or greater, and can include formats such as full HD (e.g., 1080p), retina displays, 4K (ultra-high definition or UHD), or others.

An I/O controller 740 represents hardware devices and software components related to interaction with a user. I/O controller 740 can operate to manage hardware that is part of audio subsystem 720 and/or display subsystem 730. Additionally, I/O controller 740 illustrates a connection point for additional devices that connect to device 700 through which a user might interact with the system. For example, devices that can be attached to device 700 might include microphone devices, speaker or stereo systems, video systems or other display device, keyboard or keypad devices, or other I/O devices for use with specific applications such as card readers or other devices.

As mentioned above, I/O controller 740 can interact with audio subsystem 720 and/or display subsystem 730. For example, input through a microphone or other audio device can provide input or commands for one or more applications or functions of device 700. Additionally, audio output can be provided instead of or in addition to display output. In another example, if display subsystem includes a touchscreen, the display device also acts as an input device, which can be at least partially managed by I/O controller 740. There can also be additional buttons or switches on device 700 to provide I/O functions managed by I/O controller 740.

In one embodiment, I/O controller 740 manages devices such as accelerometers, cameras, light sensors or other environmental sensors, gyroscopes, global positioning system (GPS), or other hardware that can be included in device 700. The input can be part of direct user interaction, as well as providing environmental input to the system to influence its operations (such as filtering for noise, adjusting displays for brightness detection, applying a flash for a camera, or other features). In one embodiment, device 700 includes power management 750 that manages battery power usage, charging of the battery, and features related to power saving operation.

Memory subsystem 760 includes memory device(s) 762 for storing information in device 700. Memory subsystem 760 can include two or more levels of main memory, wherein a first level of main memory (near memory) stores indirection information of a second level of main memory (far memory). The second level of main memory may include wear leveled memory devices, such as nonvolatile (state does not change if power to the memory device is interrupted) memory, for example. The first level of main memory may include volatile (state is indeterminate if power to the memory device is interrupted) memory devices, such as DRAM memory, for example. Memory 760 can store application data, user data, music, photos, documents, or other data, as well as system data (whether long-term or temporary) related to the execution of the applications and functions of system 700. In one embodiment, memory subsystem 760 includes memory controller 764 (which could also be considered part of the control of system 700, and could potentially be considered part of processor 710). Memory controller 764 includes a scheduler to generate and issue commands to memory device 762. Memory controller 764 may include near memory controller functionalities as well as far memory controller functionalities.

Connectivity 770 includes hardware devices (e.g., wireless and/or wired connectors and communication hardware) and software components (e.g., drivers, protocol stacks) to enable device 700 to communicate with external devices. The external device could be separate devices, such as other computing devices, wireless access points or base stations, as well as peripherals such as headsets, printers, or other devices.

Connectivity 770 can include multiple different types of connectivity. To generalize, device 700 is illustrated with cellular connectivity 772 and wireless connectivity 774. Cellular connectivity 772 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, LTE (long term evolution—also referred to as “4G”), or other cellular service standards. Wireless connectivity 774 refers to wireless connectivity that is not cellular, and can include personal area networks (such as Bluetooth), local area networks (such as WiFi), and/or wide area networks (such as WiMax), or other wireless communication. Wireless communication refers to transfer of data through the use of modulated electromagnetic radiation through a non-solid medium. Wired communication occurs through a solid communication medium.

Peripheral connections 780 include hardware interfaces and connectors, as well as software components (e.g., drivers, protocol stacks) to make peripheral connections. It will be understood that device 700 could both be a peripheral device (“to” 782) to other computing devices, as well as have peripheral devices (“from” 784) connected to it. Device 700 commonly has a “docking” connector to connect to other computing devices for purposes such as managing (e.g., downloading and/or uploading, changing, synchronizing) content on device 700. Additionally, a docking connector can allow device 700 to connect to certain peripherals that allow device 700 to control content output, for example, to audiovisual or other systems.

In addition to a proprietary docking connector or other proprietary connection hardware, device 700 can make peripheral connections 780 via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other type.

The following examples pertain to further embodiments.

Example 1 is a memory controller. The memory controller is configured to access indirection information stored in a first level main memory, the indirection information providing a mapping between at least one logical address and at least one physical address of a second level main memory. Further, the memory controller is configured to initiate an access of a physical memory address of the second level main memory using the indirection information stored in the first level main memory.

In Example 2, the memory controller of Example 1 can further optionally be configured to receive, from a central processing unit, a request for access to a memory portion of the second level main memory, to generate a logical address for the requested memory portion, and to look up indirection information for the memory portion in the first level main memory using the generated logical address.

In Example 3, the memory controller of Example 1 or 2 can further optionally be configured to generate a memory request for the second level main memory using the indirection information of the first level main memory, the memory request including information on a physical address of the second level main memory, and to transmit the memory request to the second level main memory.

In Example 4, the second level main memory of any of the previous Examples can further optionally be configured to modify, according to a wear leveling scheme, indirection information stored in the second level main memory, wherein the indirection information providing a mapping between one or more logical addresses and one or more corresponding physical addresses of the second level main memory. The memory controller of any of the previous Examples can further optionally be configured to receive modified indirection information from the second level main memory, and to update the indirection information of first level main memory based on the modified indirection information of the second level main memory.

In Example 5, the memory controller of any of the previous Examples can further optionally be configured to initiate a transfer of the stored indirection information from the first level main memory to the second level main memory before transiting to a low power state where content of the first level main memory of volatile memory is lost.

In Example 6, the memory controller of Example 5 can further optionally be configured to initiate an additional transfer of user data currently not stored in the second level main memory from a central processing unit or the first level main memory to the second level main memory.

In Example 7, the memory controller of Example 5 or 6 can further optionally be configured to initiate a transfer of the indirection information back from the second level main memory to the first level main memory upon resume from the low power state.

Example 8 is a memory controller for wear-leveled memory. The memory controller is configured to receive, from a remote memory controller, a memory request for the wear-leveled memory, the received memory request including information on a physical address of the wear-leveled memory. The memory controller is further configured to access the wear-leveled memory at the physical address of the received memory request.

In Example 9, the memory controller of Example 8 can further optionally be configured to modify, according to a wear leveling scheme, indirection information stored in the wear-leveled, wherein the indirection information a mapping between at least one logical address and at least one corresponding physical address of the wear-leveled memory.

In Example 10, the received memory request of Example 8 or 9 can further optionally include an indirection hint providing a potential mapping between the physical address and a received logical address generated by the remote memory controller. The memory controller of Example 8 or 9 can further optionally be configured to compare the indirection hint against actual indirection information stored in the wear-leveled memory, the actual indirection information providing an actual mapping between the received logical address and a corresponding physical addresses of the wear-leveled memory.

In Example 11, the memory controller of Example 10 can further optionally be configured to access user data at the physical address of the received memory request, if the indirection hint corresponds to the actual indirection information of the wear-leveled memory, or, to access user data at a physical address based on the actual indirection information stored in the wear-leveled memory, if the indirection hint differs from the actual indirection information of the wear-leveled memory.

In Example 12, the memory controller of any of the Examples 8 to 11 can further optionally be configured to issue a notification message indicative of an updated mapping between at least one logical memory address and at least one corresponding physical memory address of the wear-leveled memory.

In Example 13, the memory controller of Example 12 can further optionally be configured to issue the notification message using an interrupt or an asynchronous notification.

Example 14 is a memory system comprising main memory. The main memory includes first level main memory of volatile memory and second level main memory of wear-leveled memory. The first level main memory is configured to store indirection information providing reference to physical memory units of the second level main memory. The memory systems further includes at least one memory controller which is configured to initiate an access of a physical memory unit of the second level main memory using the indirection information stored in the first level main memory.

In Example 15, the memory controller of Example 14 can optionally be configured to attempt an access of user data at a physical address of the second level main memory identified by the indirection information of the first level main memory.

In Example 16, the second level main memory of any of the Examples 14 or 15 can optionally comprise a second level main memory controller configured to modify, according to a wear leveling scheme, a mapping between at least one logical address and at least one corresponding physical address of the second level main memory.

In Example 17, the memory controller of any of the Examples 14 to 16 can optionally be configured to compare indirection information of the first level main memory used to access the second level main memory against actual or current indirection information stored in the second level main memory.

In Example 18, the memory controller of Example 17 can optionally be configured to access user data at a physical address based on the actual or current indirection information stored in the second level main memory, if the indirection information of the first level main memory differs from the actual indirection information of the second level main memory.

In Example 19, the second level main memory of any of the Examples 14 to 18 can optionally be configured to issue a notification message indicative of an updated mapping between at least one logical memory address and at least one corresponding physical memory address of the second level main memory to generate updated indirection information in the first level main memory.

In Example 20, the memory controller of any of the Examples 14 to 19 can optionally be configured to initiate a transfer of the stored indirection information from the first level main memory to the second level main memory before transiting to a low power state where content of the first level main memory of volatile memory is lost.

In Example 21, the memory controller of Example 20 can be further be configured to initiate a transfer of the indirection information back from the second level main memory to the first level main memory upon resume from the low power state.

In Example 22, the memory system of any of the Examples 14 to 21 can optionally further comprise a central processing unit. The central processing unit, the memory controller and the first level main memory may be commonly integrated in a first semiconductor package.

The second level main memory may be implemented in a separate second semiconductor package.

In Example 23, an access latency of the first level main memory of any of the Examples 14 to 22 can be shorter than an access latency of the second level main memory according to the subject-matter of any of the previous Examples.

In Example 24, the first level main memory of any of the Examples 14 to 23 comprises a plurality of SRAM or DRAM memory cells.

In Example 25, the second level main memory of any of the Examples 14 to 24 comprises at least one of the group of a plurality of phase-change RAM cells, a plurality of resistive RAM memory cells, a plurality of magneto-resistive RAM memory cells, and a plurality of Flash memory cells.

In Example 26, the memory system of any of the Examples 14 to 25 can optionally further comprise a secondary memory of nonvolatile memory. The second level main memory may comprise a cached subset of the secondary memory.

In Example 27, an access latency of the second level main memory of any of the Examples 14 to 26 can be shorter than an access latency of the secondary memory according to the subject-matter of Example 26.

In Example 28, the secondary memory of any of the Examples 26 or 27 can comprise at least one of a Hard Disk Drive (HDD) storage or a Solid State Disk (SSD) storage.

Example 29 is an apparatus for a computer system using a first level of volatile memory and a second level of nonvolatile main memory. The first level of volatile memory may be a first level of volatile main memory. The apparatus comprises means for storing, in the first level of volatile memory, indirection information providing reference to physical memory addresses of the second level of nonvolatile main memory. The apparatus also comprises means for accessing a physical memory address of the second level of non-volatile main memory using the indirection information stored in the first level of volatile memory.

In Example 30, the subject-matter of Example 29 can optionally further comprise means for wear-leveling the second level of non-volatile main memory and for providing updated indirection information from the wear-leveled second level of non-volatile main memory to the first level of volatile memory.

In Example 31, the second level of nonvolatile main memory according to Example 30 can optionally be further configured to return updated indirection information to the first level of volatile memory.

In Example 32, the subject-matter of the Examples 29 to 31 can optionally further comprise means for transferring the stored indirection information from the first level of volatile memory to the second level of nonvolatile main memory before transiting to a low power state where content of the first level of volatile memory is lost.

In Example 33, the means for transferring according to the subject-matter of Example 32 may optionally be configured to transfer the indirection information back from the second level of nonvolatile main memory to the first level of volatile memory upon resume from the low power state.

In Example 34, the means for accessing according to the subject-matter of any of the Examples 29 to 33 can be configured to receive, from a central processing unit, a request for access to a memory portion, to determine whether the memory portion is associated with the second level of nonvolatile main memory. If so, the means for accessing can be configured to generate a requested logical address for the memory portion and to look up indirection information for the memory portion in the first level of volatile memory using the requested logical address.

In Example 35, the means for accessing according to the subject-matter of Example 34 may be further configured to translate the indirection information of the first level of volatile memory into a physical address of the second level of nonvolatile main memory, to access metadata at the physical address of the second level of nonvolatile main memory, the metadata comprising a logical address currently mapped to the physical address, and to determine whether the requested logical address corresponds to the logical address in the metadata. If so, the means for accessing may be configured to read/write user data from/to the physical address of the second level of nonvolatile main memory. Otherwise, the means for accessing may be configured to translate or map the requested logical address into a valid physical address of the second level of nonvolatile main memory using current indirection information stored in the second level of nonvolatile main memory, and to read/write user data from/to the valid physical address.

In Example 36, the first level of volatile memory according to the subject-matter of any of the Examples 29 to 35 comprises DRAM and the second level of nonvolatile memory according to the subject-matter of any of the Examples 29 to 35 comprises at least one of the group of phase-change RAM, resistive RAM, magneto-resistive RAM, and Flash memory.

Example 37 is a method for indirection hinting in a multi-level main memory. The method includes storing, in a first main memory level of volatile memory, indirection information providing reference from one or more logical addresses to one or more physical addresses of a second main memory level of non-volatile memory, and initiating an access of a physical memory unit of the second main memory level using the indirection information stored in the first main memory level.

In Example 38, the subject-matter of Example 37 can optionally further include wear-leveling the second main memory level of non-volatile memory.

In Example 39, the subject-matter of Example 38 can optionally further include providing updated indirection information from the wear-leveled second main memory level to the first main memory level.

In Example 40, the subject-matter of any of the Examples 37 to 39 can optionally further include transferring the stored indirection information from the first main memory level to the second main memory level before transiting to a low power state where content of the first main memory level is lost.

In Example 41, the subject-matter of Example 40 can optionally further include transferring the indirection information back from the second main memory level to the first main memory level upon resume from the low power state.

In Example 42, the subject-matter of any of the Examples 37 to 41 can optionally further include requesting, from a central processing unit, access to a memory portion of the multilevel main memory, and determining whether the memory portion is associated with the second main memory level. If the latter is true, a requested logical address is generated for the memory portion and indirection information is looked up for the memory portion in the first main memory level using the requested logical address.

In Example 43, the subject-matter of Example 42 can optionally further include issuing a memory request for the second main memory level using the indirection information of the first main memory level, the indirection information including a physical address of the second main memory level, accessing metadata at the physical address of the second main memory level, the metadata comprising a logical address currently mapped to the physical address, and determining whether the requested logical address corresponds to the logical address of the metadata. If so, user data is read/written from/to the physical address of the second main memory level. Otherwise, the requested logical address is translated into a valid physical address of the second main memory level using current indirection information stored in the second main memory level. User data is read/written from/to the valid physical address.

In Example 44, the subject-matter of Example 43 can optionally further include returning updated indirection information from the second main memory level to the first main memory level.

Example 45 is a computer program product comprising a non-transitory computer readable medium having computer readable program code embodied therein. The computer readable program code, when being loaded on a computer, a processor, or a programmable hardware component, is configured to implement a method for indirection hinting in a multi-level main memory according to any of the Examples 37 to 44.

The description and drawings merely illustrate the principles of the disclosure. It will thus be appreciated that those skilled in the art will be able to devise various alternative arrangements according to the present disclosure. Furthermore, all examples recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

Furthermore, the following claims are hereby incorporated into the detailed description, where each claim may stand on its own as a separate example embodiment. While each claim may stand on its own as a separate example embodiment, it is to be noted that—although a dependent claim may refer in the claims to a specific combination with one or more other claims—other example embodiments may also include a combination of the dependent claim with the subject matter of each other dependent or independent claim. Such combinations are proposed herein unless it is stated that a specific combination is not intended. Furthermore, it is intended to include also features of a claim to any other independent claim even if this claim is not directly made dependent to the independent claim.

It is further to be noted that methods disclosed in the specification or in the claims may be implemented by a device having means for performing each of the respective acts of these methods.

Further, it is to be understood that the disclosure of multiple acts or functions disclosed in the specification or claims may not be construed as to be within the specific order. Therefore, the disclosure of multiple acts or functions will not limit these to a particular order unless such acts or functions are not interchangeable for technical reasons. Furthermore, in some embodiments a single act may include or may be broken into multiple sub acts. Such sub acts may be included and part of the disclosure of this single act unless explicitly excluded.

What is claimed is:

1. A memory controller configured to
access indirection information stored in a first level main memory, the indirection information providing a mapping between one or more logical addresses and one or more physical addresses of a second level main memory; and
initiate an access of a physical memory address of the second level main memory using the indirection information stored in the first level main memory.

2. The memory controller of claim 1, further configured to
receive a request for access to a memory portion of the second level main memory,
generate a logical address for the requested memory portion; and
look up indirection information for the memory portion in the first level main memory using the generated logical address.

3. The memory controller of claim 1, further configured to
generate a memory request for the second level main memory using the indirection information of the first level main memory, the memory request including information on a physical address of the second level main memory, and
transmit the memory request to the second level main memory.

4. The memory controller of claim 1, wherein the second level main memory is configured to modify, according to a wear leveling scheme, indirection information stored in the second level main memory, the indirection information providing a mapping between one or more logical addresses and one or more corresponding physical addresses of the second level main memory, and wherein the memory controller is further configured to
receive modified indirection information from the second level main memory, and
update the indirection information of first level main memory based on the modified indirection information of the second level main memory.

5. The memory controller of claim 1, further configured to initiate a transfer of the stored indirection information from the first level main memory to the second level main memory before a transition to a low power state.

6. The memory controller of claim 5, further configured to initiate an additional transfer of user data currently not stored in the second level main memory from a central processing unit or the first level main memory to the second level main memory.

7. The memory controller of claim 5, further configured to initiate a transfer of the indirection information from the second level main memory to the first level main memory upon resume from the low power state.

8. A memory controller for wear-leveled memory, wherein the memory controller is configured to
receive, from a remote memory controller, a memory request for the wear-leveled memory, the received memory request including information on a physical address of the wear-leveled memory; and
access the wear-leveled memory at the physical address of the received memory request.

9. The memory controller of claim 8, further configured to
modify, according to a wear leveling scheme, indirection information stored in the wear-leveled, the indirection information a mapping between at least one logical address and at least one corresponding physical address of the wear-leveled memory.

10. The memory controller of claim 8, wherein the received memory request further includes an indirection hint providing a potential mapping between the physical address and a received logical address generated by the remote memory controller, wherein the memory controller is further configured to compare the indirection hint against actual indirection information stored in the wear-leveled memory, the actual indirection information providing an actual mapping between the received logical address and a corresponding physical addresses of the wear-leveled memory.

11. The memory controller of claim 10, further configured to
access user data at the physical address of the received memory request, if the indirection hint corresponds to the actual indirection information of the wear-leveled memory, or
access user data at a physical address based on the actual indirection information stored in the wear-leveled memory, if the indirection hint differs from the actual indirection information of the wear-leveled memory.

12. The memory controller of claim 8, further configured to issue a notification message indicative of an updated mapping between at least one logical memory address and at least one corresponding physical memory address of the wear-leveled memory.

13. The memory controller of claim 12, further configured to issue the notification message using an interrupt or an asynchronous notification.

14. A memory system, comprising:
main memory comprising
first level main memory of volatile memory;
second level main memory of wear-leveled memory;
wherein the first level main memory is configured to store indirection information providing a mapping between at least one logical address and at least one physical address of the second level main memory; and
at least one memory controller configured to initiate an access of a physical memory unit of the second level main memory using the indirection information stored in the first level main memory.

15. The memory system of claim 14, wherein the second level main memory comprises a second level main memory controller configured to modify, according to a wear leveling scheme, a mapping between at least one logical address and at least one corresponding physical address of the second level main memory.

16. The memory system of claim 14, wherein the memory controller is configured to compare indirection information of the first level main memory used to access the second level main memory against actual indirection information stored in the second level main memory.

17. The memory system of claim 16, wherein the memory controller is configured to access user data at a physical address based on the actual indirection information stored in the second level main memory, if the indirection information of the first level main memory differs from the actual indirection information of the second level main memory.

18. The memory system of claim 14, wherein the second level main memory or a controller thereof is configured to issue a notification message indicative of an updated mapping between at least one logical memory address and at least one corresponding physical memory address of the second level main memory to generate updated indirection information in the first level main memory.

19. The memory system of claim 14, wherein the memory controller is configured to initiate a transfer of the stored indirection information from the first level main memory to the second level main memory before a transition to a low power state where content of the first level main memory of volatile memory and wherein the memory controller is configured to initiate a transfer of the indirection information back from the second level main memory to the first level main memory upon resume from the low power state.

20. The memory system of claim 14, further comprising:
a central processing unit,
wherein the central processing unit, the memory controller and the first level main memory are commonly integrated in a first semiconductor package, and
wherein the second level main memory is implemented in a separate second semiconductor package and
a network interface communicatively coupled to the central processing unit.

21. The memory system of claim 14, wherein an access latency of the first level main memory is shorter than an access latency of the second level main memory.

22. The memory system of claim 14, wherein the first level main memory comprises a plurality of SRAM or DRAM memory cells and wherein the second level main memory comprises at least one of the group of a plurality of phase-change RAM cells, a plurality of resistive RAM memory cells, a plurality of magneto-resistive RAM memory cells, and a plurality of Flash memory cells.

23. A method for indirection hinting in a multi-level main memory, comprising:
storing, in a first main memory level of volatile memory, indirection information providing reference from one or more logical addresses to one or more physical addresses of a second main memory level of non-volatile memory; and
initiating an access of a physical memory unit of the second main memory level using the indirection information stored in the first main memory level.

24. The method of claim 23, further comprising
wear-leveling the second main memory level of non-volatile memory.

25. The method of claim 24, further comprising
providing updated indirection information from the wear-leveled second main memory level to the first main memory level.
